(19) United States
(12) Patent Application Publication
(10) Pub. No.: US 2003/0059289 A1
(43) Pub. Date: Mar. 27, 2003

(54) Wafer cassette transport cart with self correcting fault alignment block and method

(75) Inventor: Hoon-Yeng Yap, Tempe, AZ (US)

Correspondence Address: Schwegman, Lundberg, Woessner & Kluth, P.A, P.O. Box 2938, Minneapolis, MN, 55402, US

(73) Assignee: Intel Corporation

(21) Appl. No.: 09/962,556

(22) Filed: Sep. 25, 2001

(51) Int. Cl. B60P 1/00; B25J 1/00

(52) U.S. Cl. 414/541; 269/17

(57) ABSTRACT

A wafer cassette transport cart and fault-tolerant self-correcting block help a wafer cassette to properly seat on the pickup forks of the wafer cassette transport cart. The block has a lower surface to mount to the cart and an angled upper surface to meet a front bottom edge of a wafer cassette. The angled upper surface causes an improperly positioned wafer cassette to slide to a proper seating position on the cart when the wafer cassette is lowered onto the cart. The fault-tolerant self-correcting block is fabricated from clean-room compatible materials and the upper angled upper surface may have a low-resistance coating.

### FIELD OF THE INVENTION

The present invention pertains to semiconductor fabrication wafer handing assemblies, and in particular, to apparatus for transporting semiconductor wafer cassettes between processing environments, and more particularly to semiconductor wafer cassette transport carts.

### BACKGROUND OF THE INVENTION

In a semiconductor wafer processing environment, semiconductor wafers are protected from contaminants and physical agitation through the use of a sealable container called a wafer pod or cassette. Such cassettes generally have a series of interior ridges on opposing sides to support a batch of wafers horizontally, and a door to allow access to the contents. A cassette transport cart, sometimes referred to as personal guided vehicle (PGV), may be used to transport wafer cassettes to minimize human manipulation which can lead to dropping and bumping of a loaded cassette resulting in damage and loss of wafer stock. Such wafer cassette transport carts are used to transport cassettes between different processing stations during the various phases of the wafer manufacturing.

In general, at a wafer processing station, pickup forks of the wafer cassette transport cart guide the wafer cassette onto a support platform, which includes an arrangement of pins having beveled tops called a nest, which mate with corresponding beveled receptacles on the bottom of the wafer cassette. The beveled tops allow precise, consistent placement while affording some tolerance for movement when placing the cassette on the pins. Removal of the cassette from the nested position on the pin assemblies can involve insertion of the pickup forks under the cassette between the pin assemblies, and lifting upwards. Wafer cassette transport carts generally have mechanisms to move the pickup forks into position under the wafer cassette, to lift the wafer cassette off the processing equipment support platform, and move the wafer cassette back to the transport cart, lowering the wafer cassette into a seated position on the transport cart. The mechanisms employed by wafer cassette transport carts may be human controlled or may be automated. Once the wafer cassette is returned to the seating position on the transport cart, the wafer cassette may be transported, for example, to another processing station.

One problem with the design of conventional wafer cassette transport carts is that when a wafer cassette is placed on the transport cart or when a wafer cassette is withdrawn from a processing station and moved to a position on the transport cart, the wafer cassette fails to be properly located at a fully seated position on the cart. This situation allows the wafer cassette to easily fall off the cart or to be dropped.

Manufactures of wafer cassette transport carts have attempted to reduce the likelihood of wafer cassettes falling from a cart by installing pins on the front rail of the wafer cassette transport cart. However, many times, the operator of the cart fails to recognize when the wafer cassette is not in a fully seated position. For example, when the cassette is placed on the cart or moved to a seating position on the cart from the processing station, the cassette may be inadvertently positioned with a portion of the wafer cassette on top of stopper pins, making it even more likely the wafer cassette will fall off the cart. The use of spring-loaded stopper pins has further contributed to this risk of falling when the wafer cassette is not in a fully seated position on the cart.

Thus there is a need for an apparatus and method that improves the security of wafer cassette transport. There is also a need for an apparatus that reduces the chances of wafer cassettes falling from the transport cart. There is also a need for an improved wafer cassette transport cart that improves the security of wafer cassettes. There is also a need for an apparatus that properly aligns wafer cassettes on wafer cassette transport carts.

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures and:

FIG. 1A is an isometric view of a conventional wafer cassette transport cart;

FIG. 1B is an enlarged view of the section in FIG. 1A labeled 1B-1B illustrating a stopper pin on a convention wafer cassette transport cart;

FIG. 2A is a top view of a wafer cassette;

FIG. 2B is a side view of a wafer cassette properly seated on a conventional wafer cassette transport cart;

FIG. 3A is a side view of a wafer cassette misaligned on a conventional wafer cassette transport cart;

FIG. 3B is an enlarged view of the section in FIG. 3A labeled 3B-3B illustrating an enlarged portion of a side view of a wafer cassette misaligned on a conventional wafer cassette transport cart;

FIG. 4 is an isometric view illustrating a wafer cassette transport cart in accordance with an embodiment of the present invention;

FIG. 5 is a side view of a wafer cassette in a proper seating position of a wafer cassette transport cart in accordance with an embodiment of the present invention;

FIG. 6A is a front view of a portion of a wafer cassette in a proper seating position of a wafer cassette transport cart in accordance with an embodiment of the present invention;

FIG. 6B is a side view of a portion of a wafer cassette in a proper seating position of a wafer cassette transport cart in accordance with an embodiment of the present invention;

FIG. 7 is a side view of a wafer cassette misaligned on a wafer cassette transport cart in accordance with an embodiment of the present invention;

FIG. 8 is a side view of a wafer cassette located at a processing station position in accordance with an embodiment of the present invention;

FIG. 9 is a side view of a larger style wafer cassette located on a wafer cassette transport cart in accordance with an embodiment of the present invention;

FIG. 10A is a rear view of a self-correcting fault-tolerant block in accordance with an embodiment of the present invention;

FIG. 10B is a bottom view of a self-correcting fault-tolerant block in accordance with an embodiment of the present invention;

FIG. 10C is a right-side view of a self-correcting fault-tolerant block in accordance with an embodiment of the present invention; and

FIG. 10D is a right-side view of a self-correcting fault-tolerant block in accordance with an alternate embodiment of the present invention.

The description set out herein illustrates the various embodiments of the invention and such description is not intended to be construed as limiting in any manner.

### DETAILED DESCRIPTION

The present invention generally relates to wafer cassette transport carts and mechanisms to align wafer cassettes on wafer cassette transport carts. In one embodiment, the present invention provides a wafer cassette transport cart with a fault-tolerant self-correcting block. The fault-tolerant self-correcting block helps the wafer cassette properly seat itself on the pickup forks of the wafer cassette transport cart. In another embodiment, the present invention provides a fault-tolerant self-correcting block for use on a wafer cassette transport cart. The fault-tolerant self-correcting block has a lower surface to mount to a wafer cassette transport cart, and an angled upper surface to meet a front-bottom edge of a wafer cassette. The angled upper surface causes the wafer cassette to slide to a proper seating position on the wafer cassette transport cart when the wafer cassette is lowered onto the wafer cassette transport cart.

In another embodiment, the present invention provides a method of aligning a wafer cassette on a wafer cassette transport cart. A self-correcting fault-tolerant block is installed on a fixed member of a wafer cassette transport cart. The self-correcting fault-tolerant block has a lower surface to mount to the fixed member and an angled upper surface. A front bottom edge of the wafer cassette is positioned on the angled upper surface, and the wafer cassette is allowed to slide into a proper seating position on the wafer cassette transport cart. The front-bottom edge of the wafer cassette slides along the angled upper surface of the block.

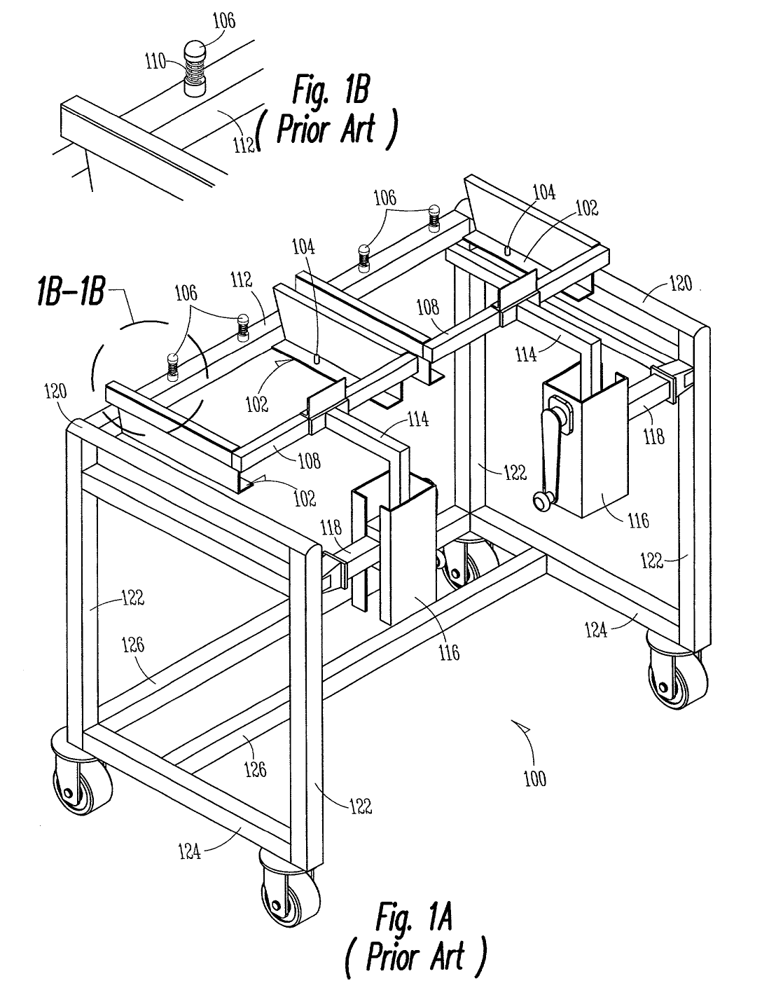

FIG. 1A is an isometric view illustrating a conventional wafer cassette transport cart. Conventional wafer cassette transport cart 100 generally includes three groups of elements: stationary elements, wafer cassette support elements for supporting a wafer cassette, and position transfer elements for transferring a wafer cassette from a position on the cart to a position outside the cart such as a processing station position. FIG. 1A does not illustrate all of the details of a conventional wafer cassette transport cart, but illustrates only the essential features which are necessary for understanding the present invention. The stationary elements include portions of the cart that are fixed and generally do not move with respect to the cart. Stationary elements generally comprise the structural elements of conventional wafer cassette transport cart 100 and include upper horizontal fixed members 120, lower horizontal fixed members 124 and 126, vertical fixed members 122 and front rail 112. The stationary elements couple to the position transfer elements, which generally include vertical movement mechanism 116 and horizontal movement mechanism 118. The position transfer elements provide an interface between the stationary elements and the wafer cassette support elements, as well as providing for the position transfer of the wafer cassette support elements. The wafer cassette support elements comprise wafer cassette pickup forks 102 for supporting a wafer cassette, back rail 108 coupling to pickup forks 102, and arm 114 coupling back rail 108 to the position transfer elements. Pickup forks 102 may include cassette alignment pins 104 which are intended to align with pin alignment holes of a wafer cassette when a wafer cassette is properly positioned on pickup forks 102.

Mechanisms 116 and 118, for example, may be slidably mounted on one or both horizontal fixed members 120 permitting the cassette support elements to slide horizontally, as well as permitting the cassette support elements to be move vertically, thereby providing for both horizontal and vertical movement of a wafer cassette positioned on forks 102. Mechanisms 116 and 118 may be controlled by a human operator, and may employ many types of movement mechanisms, including for example, a lever or a crank (as shown). Mechanisms 116 and 118 may also be controlled by electromechanical mechanisms and may be fully automated or human operator controlled. Other type of mechanisms for providing horizontal and vertical movement to a wafer cassette have been used on convention wafer cassette transport carts. Conventional wafer cassette transport cart 100 includes front rail stopper pins 106 fixed to front rail 112. Stopper pins 106 are intended to help prevent a properly seated wafer cassette from falling or sliding forward of front rail 112. Stopper pins are generally either solid or spring-loaded. FIG. 1B is an enlarged view of the section in FIG. 1A labeled 1B-1B illustrating spring loaded stopper pins 106 as used on a convention wafer cassette transport cart. Spring loaded stopper pin 106 includes spring 110.

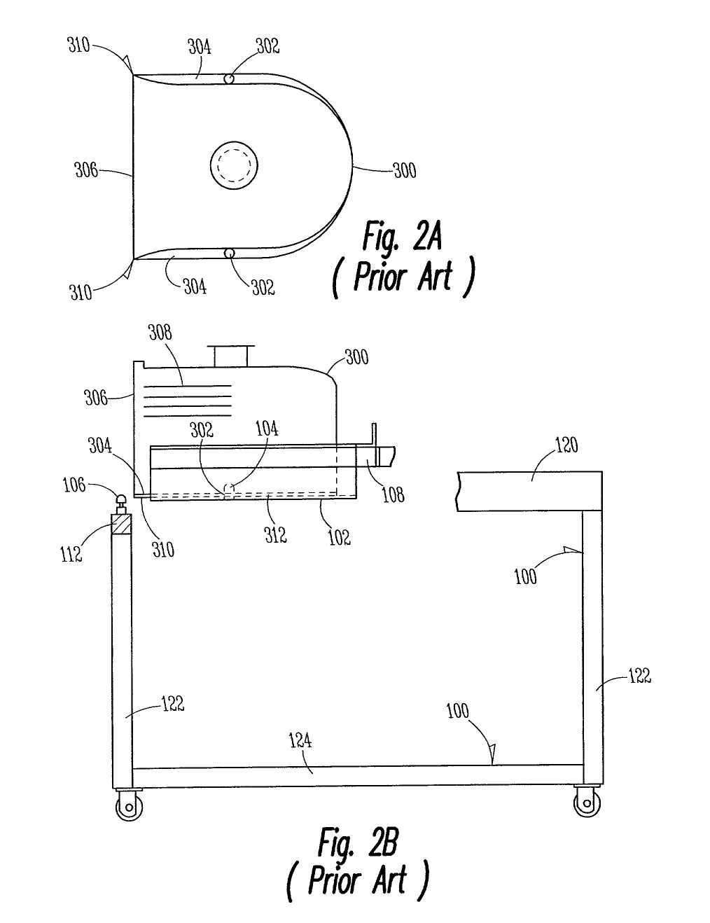

FIG. 2A is a top view of a conventional wafer cassette. Wafer cassette 300 is a semiconductor wafer cassette which generally consists of a rectangular box which may have a curved rear section when viewed from above. FIG. 2A does not illustrate all of the details of a conventional wafer cassette, but illustrates only the essential features which are necessary for understanding the present invention. FIG. 2B is a side view of a wafer cassette properly seated on a conventional wafer cassette transport cart. For ease in understanding, only a portion of a wafer cassette transport cart are illustrated in FIG. 2B. The portion illustrated corresponds with like numbered elements of wafer cassette transport cart 100 (FIG. 1). Wafer Cassette 300 includes wafer cassettes that are known as front opening unified pods (FOUPs) and front opening shipping boxes (FOUBs), as well as frame carriers and other boxes suitable for transporting semiconductor wafers.

Wafer cassette 300 may have base flange 304 protruding from the base of cassette 300 with pin alignment holes 302. Pin alignment holes 302 are intended to receive wafer cassette alignment pins 104 located on pickup forks 102 of wafer cassette transport cart 100 when wafer cassette 300 is properly seated on pickup forks 102. Although the present invention is described for use with wafer cassettes and cassette transport carts that use wafer cassette pin alignment holes 302 and wafer cassette alignment pins 104 for alignment of the wafer cassette on a wafer cassette transport cart, the present invention is equally suitable to wafer cassettes that do not have wafer cassette pin alignment holes and wafer cassette transport carts that do not include wafer cassette alignment pins for alignment of a wafer cassette on the wafer cassette transport cart. Wafer cassette 300 may have a series of interior ridges on opposing sides to support semiconductor wafers 308 in a horizontal position as shown. Wafer cassette 300 may also have a door (not shown) on front surface 306 to allow access to the contents. Semiconductor wafers 308 are preferably 300 millimeter diameter silicon wafers, although other size and wafer types are also suitable for use with the various embodiments of the present invention.

In FIG. 2B, wafer cassette 300 is illustrated as properly seated on conventional wafer cassette transport cart 100. When wafer cassette 300 is properly positioned on pickup forks 102, alignment pins 104 are aligned with wafer cassette alignment pin holes 302 of wafer cassette 300. Pickup forks 102 position wafer cassette 300 such that lower front edge 310 of wafer cassette 300 is located behind, for example, stopper pins 106 as illustrated in FIG. 2B.

Additionally, when wafer cassette 300 is properly seated on a wafer cassette transport cart, pickup forks 102 may be positioned such that bottom 312 of wafer cassette 300 is about 1.25 centimeters higher than the top of front rail 112 as illustrated in FIG. 2B. The position of wafer cassette 300 with respect to the elements of a transport cart illustrated in FIG. 2B may also be a proper seating position for transport carts do not use stopper pins.

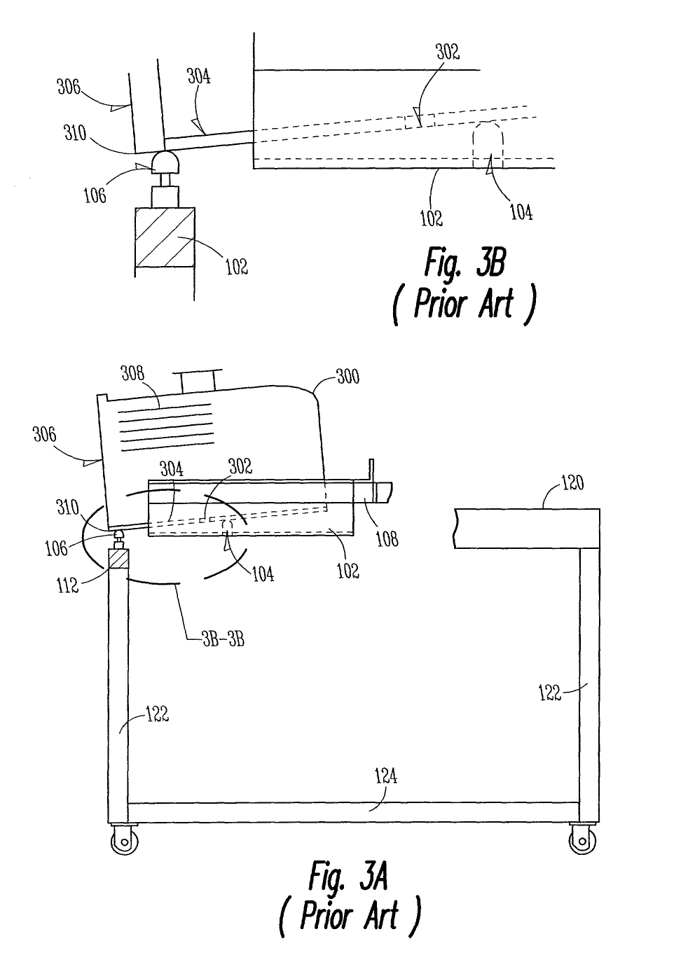

FIG. 3A is a side view of a wafer cassette misaligned on a conventional wafer cassette transport cart. FIG. 3B is an enlarged view of the section in FIG. 3A labeled 3B-3B illustrating a portion of a side view of a wafer cassette misaligned on a conventional wafer cassette transport cart. Wafer cassette 300 as illustrated in FIG. 3A is not located in the proper seating position within wafer cassette transport cart 100. Lower front edge 310 of wafer cassette 300 is located above front rail 112 of wafer cassette transport cart 100 rather than behind front rail 112. Furthermore, lower front edge 310 is located on top of stopper pins 106 rather than behind stopper pins 106. As illustrated in FIG. 3B, stopper pins 106 are compressed by the weight of wafer cassette 300. Pickup forks 102 are positioned about 1.25 centimeters above the top of front rail 112 which would normally position wafer cassette 300 in a proper seating position if wafer cassette 300 were positioned on pickup forks 102 properly.

This improper seating condition may occur, for example, when wafer cassette 300 is placed on wafer cassette transport cart 100 and an operator fails to realize that wafer cassette 300 is not properly seated. For example, the operator may fail to realize that wafer cassette pin alignment holes 302 are not aligned with wafer cassette alignment pins 104 of pickup forks 102, or that wafer cassette 300 is sitting on top of stopper pins 106. This improper seating condition may also occur when wafer cassette 300 is withdrawn from processing equipment with pickup forks 102 and returned to wafer cassette transport cart 100. Because wafer cassette alignment pins 104 are typically very short (i.e., generally less than one centimeter high) in comparison to wafer cassette 300, and because stopper pins are also very short (e.g., generally less than 2.5 centimeters high) in comparison to a wafer cassette, it is easy for an operator to fail to recognize when a wafer cassette is seated improperly on a wafer cassette transport cart.

An improperly seated wafer cassette can easily fall from the wafer cassette transport cart, damaging the expensive semiconductor wafers 308. The chances of a wafer cassette falling are even more likely when stopper pins 106 are spring-loaded, because some weight of wafer cassette 300 is supported by the springs, causing the wafer cassette to bounce when the wafer cassette transport cart is moved. As can be seen, a wafer cassette transport cart and apparatus that help to properly seat a wafer cassette would be highly beneficial.

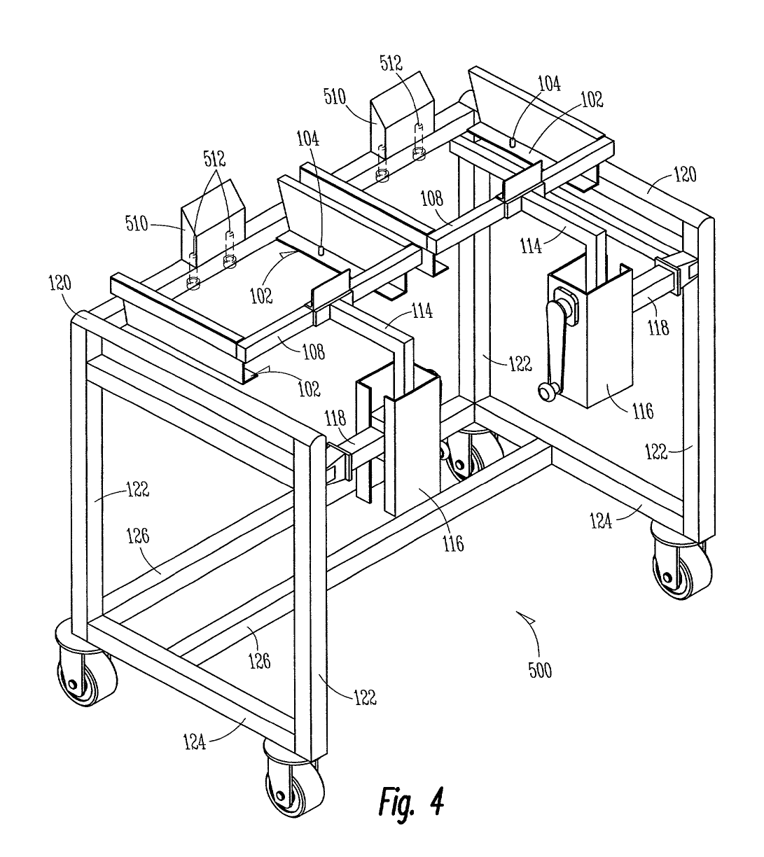

FIG. 4 is an isometric view illustrating a wafer cassette transport cart in accordance with an embodiment of the present invention. Wafer cassette transport cart 500 may be similar to conventional wafer cassette transport cart (FIG. 1), except that wafer cassette transport cart 500 includes self-correcting fault-tolerant block 510 instead of stopper pins 106 (FIG. 1). Self-correcting fault-tolerant block 510 is as high as or higher than stopper pins 106 (FIG. 1) having a height ranging from, for example, 5 to 10 centimeters. Self correcting fault tolerant block 510 is fixed to front rail 112 by coupling elements 512 which may be screws or bolts. Alternatively, an adhesive suitable for clean-room environments may be used to fix self-correcting fault-tolerant block 510 to front rail 112. Although wafer cassette transport cart 500 illustrates vertical and horizontal movement mechanisms 116, 118 as being a specific type, this is only to serve as an example for understanding the embodiments of the present invention, as the specific type of mechanisms for providing horizontal and vertical movement to a wafer cassette are not essential to the present invention

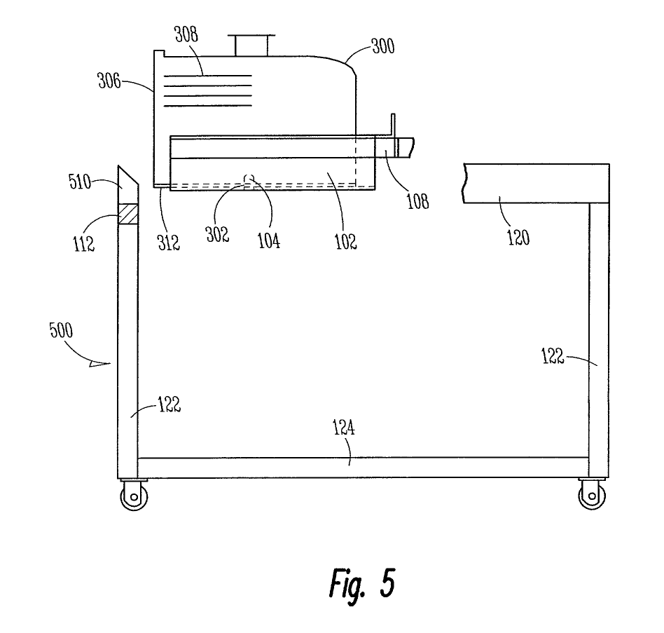

FIG. 5 is a side view of a wafer cassette in a proper seating position of a wafer cassette transport cart in accordance with an embodiment of the present invention. In FIG. 5, wafer cassette 300 is illustrated as properly seated on wafer cassette transport cart 500. When wafer cassette 300 is properly seated on a wafer cassette transport cart, pickup forks 102 position wafer cassette 300 such that lower front edge 310 of wafer cassette 300 is located behind self-correcting fault-tolerant block 510 as illustrated in FIG. 5. Additionally, when wafer cassette 300 is properly seated on wafer cassette transport cart 500, pickup forks 102 may be positioned such that bottom 312 of wafer cassette 300 is about 1.25 centimeters higher than the top of front rail 112 as illustrated in FIG. 5.

In one embodiment of the present invention, wafer cassette transport cart 500 includes wafer cassette alignment pins 104 on pickup forks 102 for use with wafer cassettes that have wafer cassette pin alignment holes 302. In this embodiment, when wafer cassette 300 is properly positioned on pickup forks 102, wafer cassette alignment pins 104 are aligned with wafer cassette alignment pin holes 302 of wafer cassette 300.

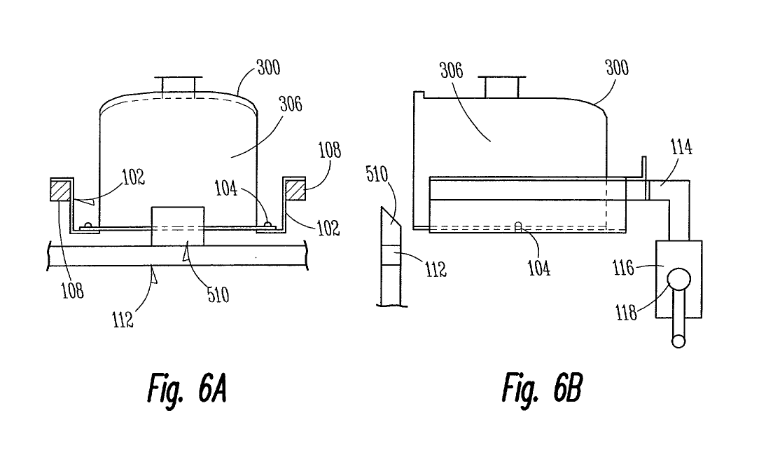

FIG. 6A is a front view of a portion of a wafer cassette in a proper seating position of a wafer cassette transport cart in accordance with an embodiment of the present invention. FIG. 6B is a side view of a portion of a wafer cassette in a proper seating position of a wafer cassette transport cart in accordance with an embodiment of the present invention.

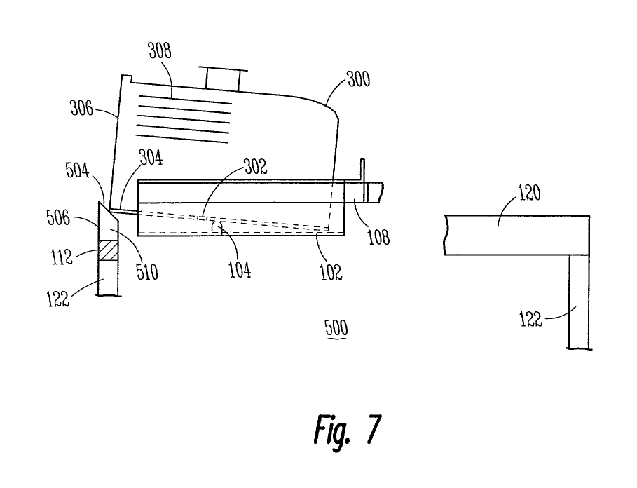

FIG. 7 is a side view of a wafer cassette misaligned on wafer cassette transport cart 500 in accordance with an embodiment of the present invention. Wafer cassette 300 as illustrated in FIG. 7 is not located in the proper seating position on wafer cassette transport cart 500, even though pickup forks 102 are lowered in a position approximately 1.25 centimeters above the top of front rail 112. Lower front edge 310 of wafer cassette 300 is located above front rail 112 of the transport cart rather than behind front rail 112. Furthermore, lower front edge 310 is located on top of self-correcting fault-tolerant block 510 rather than behind self-correcting fault-tolerant block 510. This improper seating condition may occur, for example, when wafer cassette 300 is placed on wafer cassette transport cart 500 and an operator fails to realize that the wafer cassette is not properly seated. For example, in embodiments that use wafer cassette alignment pins 104, the operator may fail to realize that wafer cassette pin alignment holes 302 are not aligned with wafer cassette alignment pins 104 of pickup forks 102, or that wafer cassette 300 is sitting on self-correcting fault-tolerant block 510. This improper seating condition may also occur when wafer cassette 300 is withdrawn from processing equipment with pickup forks 102 and returned to wafer cassette transport cart 500.

When an improper seating condition occurs, such as the one illustrated in FIG. 7, lower front edge 310 of wafer cassette 300 slides down angled upper surface 504 of self-correcting fault-tolerant block 510 to position wafer cassette 300 into the proper seating position illustrated in FIG. 6. Angled upper surface 504 may be provided with a coating to help facilitate the sliding. An operator may also use angled upper surface 504 to properly seat wafer cassette 300 by sliding lower front edge 310 down angled upper surface 504 into a proper seating position. As can be seen, the use of self-correcting fault-tolerant block 510 makes it significantly more difficult for wafer cassette 300 to be improperly seated on wafer cassette transport cart 500, as compared, for example, to conventional wafer cassette transport carts.

Furthermore, because self-correcting fault-tolerant block 510 is sufficiently high, extreme misalignments are easier to detect. For example, when wafer cassette 300 is placed on wafer cassette transport cart 500 with lower front edge 310 in front of front surface 506 of self-correcting fault-tolerant block 510, the height of self-correcting fault-tolerant block 510 results in an angling of wafer cassette 300 that should be easily detected by an operator. Angled upper surface 504 also allows misalignment to be easily corrected by operator. Thus, self-correcting fault-tolerant block 510 also serves as a visual indicator when a wafer cassette is extremely misaligned. If an operator fails to detect an extreme misalignment, wafer cassette 300 is angled further back. This angled position further reduces the change that wafer cassette 300 will fall from wafer cassette transport cart 500 because, for example, the weight of wafer cassette 300 is shifted further back onto wafer cassette transport cart 500.

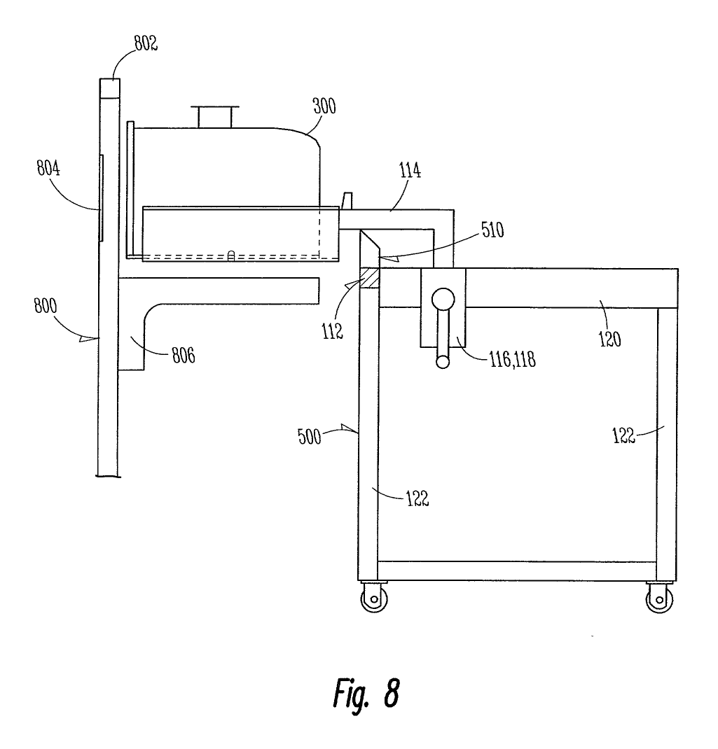

FIG. 8 is a side view of a wafer cassette located at a processing station position in accordance with an embodiment of the present invention. Processing equipment 800 is located behind processing equipment interface 802 and accessed through processing equipment door 804. As illustrated, wafer cassette 300 is positioned on processing station platform 806 for access by processing equipment 800 through door 804. Mechanisms 116 and 118 on wafer cassette transport cart 500 are configured to move wafer cassette 300 from a seated position on wafer cassette transport cart 500 to a seated position on processing station platform 806. Mechanisms 116 and 118, for example, may lift wafer cassette 300 on pickup forks 102, may move wafer cassette 300 from wafer cassette transport cart 500 to processing station platform 806, and may lower wafer cassette 300 onto processing station platform 806. Mechanisms 1 16 and 118 may use arm 114 to lift pickup forks 102 sufficiently high enough to clear self-correcting fault-tolerant block 510. Because self-correcting fault-tolerant block 510 may be higher than, for example, stopper pins 106 (FIG. 1), wafer cassette 300 cannot be simply slid back onto wafer cassette transport cart 500 without being raised over self-correcting fault-tolerant block 510. This further increases the chances that an operator will properly seat wafer cassette 300 on wafer cassette transport cart 500.

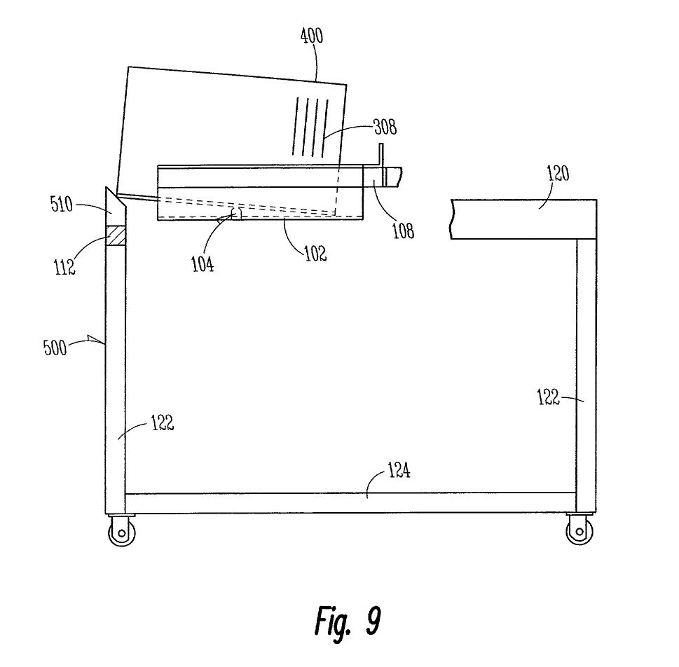

FIG. 9 is a side view of a larger style wafer cassette located on the wafer cassette transport cart in accordance with an embodiment of the present invention. Larger style wafer cassettes are sometimes transported on wafer cassette transport carts designed for wafer cassettes of a standard size. For example, the wafer cassette transport carts illustrated in FIGS. 1-8 may be designed for wafer cassettes of a certain size which allows a standard size wafer cassette to sit level on pickup forks 102 when the wafer cassette is in a proper seating position. Other size wafer cassettes, such as wafer cassettes that are longer, for example larger style wafer cassette 400, may be too long to sit on pickup forks 102 when pickup forks 102 are positioned as illustrated in FIG. 9.

Larger style wafer cassette 400 is longer than wafer cassette 300 and may not be able to be positioned in a proper seating position on wafer cassette transport cart 500. Larger style wafer cassette 400 may also be higher than wafer cassette 300. Larger style wafer cassette 400 is therefore positioned as illustrated in FIG. 9. The additional height of self-correcting fault-tolerant block 510 shifts the weight of larger style wafer cassette 400 back, which reduces the likelihood that larger style wafer cassette 400 will fall from the cart. When conventional wafer cassette transport carts 100 (FIG. 1) and with stopper pins 106 (FIG. 2) are used, a larger style wafer cassette is more likely to fall from the cart. The likelihood of a larger style wafer cassette falling is even greater when a conventional wafer cassette transport cart is fitted with spring-loaded stopper pins because some of the weight of the larger style wafer cassette is support by the springs allowing the sprung weigh to shift and bounce.

Although the example wafer cassette transport carts illustrated in the figures are shown as providing for the transport of two wafer cassettes, the description herein and the embodiments of the present invention are equally applicable to wafer cassette transports carts that support a single wafer cassette, or for example, more than two wafer cassettes. Furthermore, the wafer cassette transport carts in the figures illustrate examples of wafer cassette transport carts which are helpful for understanding the various embodiments the present invention. Other wafer cassette transport cart designs are also intended to be within the scope of the present invention.

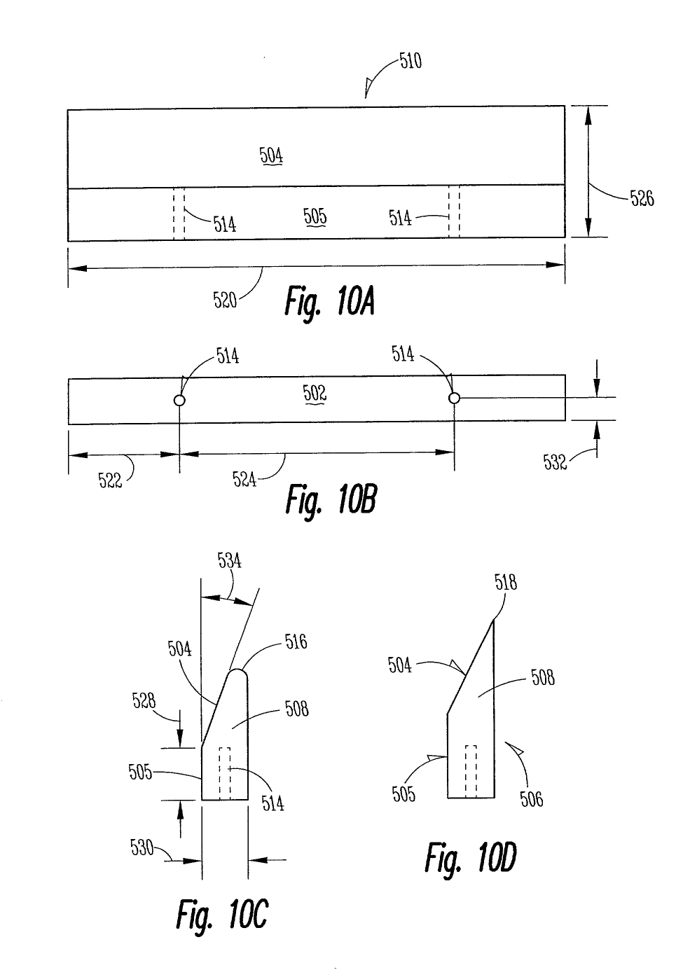

FIG. 10A is a rear view of a self-correcting fault-tolerant block in accordance with an embodiment of the present invention. FIG. 10B is a bottom view of a self-correcting fault-tolerant block in accordance with an embodiment of the present invention. FIG. 10C is a right-side view of a self-correcting fault-tolerant block in accordance with an embodiment of the present invention. FIG. 10D is a right-side view of a self-correcting fault-tolerant block in accordance with an alternate embodiment of the present invention. Self-correcting fault-tolerant block 510 has lower surface 502, angled upper surface 504, rear surface 505, front surface 506 and side surfaces 508.

In one embodiment, self-correcting fault-tolerant block 510 includes recesses 514 for accepting coupling elements 512 (FIG. 4). Although FIG. 10 illustrates two recesses 514, self-correcting fault-tolerant block 510 may have no recesses, or, alternatively, may have more than two recesses, depending on how self-correcting fault-tolerant block 510 is secured to a member of a wafer cassette transport cart. When self-correcting fault-tolerant block 510 has no recesses, a clean-room compatible adhesive may be used to secure self-correcting fault-tolerant block 510 to a member of a wafer cassette transport cart.

In accordance with one embodiment, lower surface 502 is intended to mount to a front rail of a wafer cassette transport cart. Lower surface 502 may be configured to mount to a fixed element of a wafer cassette transport cart that may not be flat. For example, lower surface 502 may be curved to match a curved front rail of a wafer cassette transport cart. Angled upper surface 504 meets with a front-bottom edge of the wafer cassette to cause the wafer cassette to slide from a first position into a second position on pickup forks of a wafer cassette transport cart when the lifting mechanism lowers the wafer cassette to the transport cart seating position. Front surface 506 is substantially perpendicular to lower surface 502, and rear surface 505 is located in a plane substantially parallel with front surface 506. Angled upper surface 504 meets with rear surface 505 and front surface 506 to define two dimensions of the self-correcting fault-tolerant block. Angled upper surface 504 may be located in a plane at first angle 534 from a plane of rear surface 505. In one embodiment, angle 534 may be between ten and thirty degrees. In one embodiment, curved surface 516 is provided between angled upper surface 504 and front surface 506 (see FIG. 10C). In another embodiment, angled upper surface 504 meets front surface 506 to form pointed edge 518 (see FIG. 10D).

In accordance with the embodiments of the present invention, self-correcting fault-tolerant block 510 has height 526 ranging between 5 and 10 centimeters and length 520 ranging between 12 and 40 centimeters. Length 520 may depend on the width of wafer cassettes 300 and spacing between pickup forks 102 (FIG. 5). Self-correcting fault-tolerant block 510 has width 530 that may range between 2 and 4 centimeters. Width 530 is desirably about the same as the width of front rail 112 of wafer cassette transport cart 500 (FIG. 5). Rear surface height 528 may range between 1 and 5 centimeters.

Self-correcting fault-tolerant block 510 may be comprised of many materials and is desirably fabricated from ESD approved clean-room compatible materials. Examples of possible materials that could be used includes fiber reinforced molded polymers, Derlin (trademark) or PTFE (Teflon (trademark)) coated metals such as aluminum or titanium. Other materials may be used without departing from this invention. Such materials could be selected by one skilled in the art given this disclosure such as aluminum or Derlin. In accordance with one embodiment, at least angled upper surface 504 may be comprised of or may be coated with a low-resistance clean-room compatible material, such as a Teflon or Derlin type material to help lower front edge 310 of wafer cassette 300 (FIG. 7) slide along angled upper surface 504. A low-resistance clean-room compatible insert may also be used for angled upper surface 504.

In the embodiments of self-correcting fault-tolerant block 510 that include recesses 514, spacing 524 between recesses 514 may correspond with the spacing between screw or bolt holes used to secure stopper pins 106 on conventional wafer cassette transport cart 100 (FIG. 1). Spacing 524, for example, may range between 6 and 30 centimeters and have offset 522 from side surface 508 ranging between 2 and 17 centimeters. Recesses 514 have offset 532 from rear surface 505 that may range between 1 and 3 centimeters.

The wafer cassette transport cart and a self-correcting fault-tolerant block of the present invention allow wafer cassettes to be self-aligned into a proper seating position within the cart, and reduce the likelihood that a wafer cassette will fall from the wafer cassette transport cart. Wafer cassettes that are misaligned slide along an angled upper surface of the self-correcting fault-tolerant block into the proper seating position. In addition, the wafer cassette transport cart allows an operator to more easily detect and correct extreme misalignments of a wafer cassette. The wafer cassette transport cart of the present invention is also suitable for use with larger style wafer cassettes and reduces the likelihood that such larger style wafer cassettes will fall, by shifting more of their weight towards the cart.

The foregoing description of the specific embodiments reveals the general nature of the invention sufficiently that others can, by applying current knowledge, readily modify and/or adapt it for various applications without departing from the generic concept, and therefore such adaptations and modifications are intended to be comprehended within the meaning and range of equivalents of the disclosed embodiments.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A wafer cassette transport cart, comprising:
a wafer cassette support apparatus having pickup forks to support a wafer cassette;
a mechanism coupled to the wafer cassette support apparatus to transfer the wafer cassette between a position within the cart and a processing position; and
a self-correcting fault-tolerant block located on a fixed member of to reposition the wafer cassette on the pickup forks to a proper seating position when the wafer cassette is positioned on the cart.

2. The cart as claimed in claim 1 wherein the self-correcting fault-tolerant block comprises:
a lower surface to mount to the fixed member of the cart; and
an angled upper surface to meet a front-bottom edge of the wafer cassette to cause the wafer cassette to slide to the proper seating position when the wafer cassette is lowered onto the cart.

3. The cart as claimed in claim 2 wherein the self-correcting fault-tolerant block causes the wafer cassette to reposition on the pickup forks when the wafer cassette is positioned forward of a rear edge of the fixed member when being returned to the cart.

4. The cart as claimed in claim 2 wherein the self-correcting fault-tolerant block further comprises:
a front surface substantially perpendicular to the lower surface; and
a rear surface located in a plane substantially parallel with the front surface.

5. The cart as claimed in claim 4 wherein the angled upper surface is located in a plane at a first angle from a plane of the rear surface, the first angle being between ten and thirty degrees.

6. The cart as claimed in claim 5 wherein the angled upper surface meets the front surface at a second angle to form a pointed edge.

7. The cart as claimed in claim 5 wherein the self-correcting fault-tolerant block comprises a curved surface between the angled upper surface and the front surface.

8. The cart as claimed in claim 5 wherein the self-correcting fault-tolerant block includes recesses in the lower surface to receive coupling elements to mount the self-correcting fault-tolerant block to the fixed member of the cart.

9. The cart as claimed in claim 2 wherein the self-correcting fault-tolerant block is comprised of aluminum.

10. The cart as claimed in claim 2 wherein the angled upper surface is comprised of a low resistance clear room compatible material.

11. A self-correcting fault-tolerant block for aiding alignment of wafer cassettes on a wafer cassette transport cart, the self-correcting fault-tolerant block comprising:
a lower surface to mount to a front rail of the wafer cassette transport cart; and
an angled upper surface to meet a front-bottom edge of a wafer cassette to cause the wafer cassette to slide into a proper seating position when the wafer cassette is lowered onto the wafer cassette transport cart.

12. The self-correcting fault-tolerant block as claimed in claim 11 further comprising:
a front surface substantially perpendicular to the lower surface; and
a rear surface located in a plane substantially parallel with the front surface.

13. The self-correcting fault-tolerant block as claimed in claim 12 wherein the angled upper surface is located in a plane at a first angle from a plane of the rear surface, the first angle being between ten and thirty degrees.

14. The self-correcting fault-tolerant block as claimed in claim 13 wherein the angled upper surface meets the front surface at a second angle to form a pointed edge.

15. The self-correcting fault-tolerant block as claimed in claim 13 further comprising a curved surface between the angled upper surface and the front surface.

16. The self-correcting fault-tolerant block as claimed in claim 12 further comprising recesses in the lower surface to receive coupling elements to mount the self-correcting fault-tolerant block to the front rail of the wafer cassette transport cart.

17. The self-correcting fault-tolerant block as claimed in claim 12 wherein the self-correcting fault-tolerant block is comprised of aluminum.

18. The self-correcting fault-tolerant block as claimed in claim 12 wherein the angled upper surface is comprised of a low resistance clear room compatible material.

19. A method of aligning a wafer cassette on a wafer cassette transport cart comprising:
installing a self-correcting fault-tolerant block on a fixed member of a wafer cassette transport cart, the self-correcting fault-tolerant block having a lower surface to mount to the fixed member, and an angled upper surface;
positioning a front bottom edge of the wafer cassette on the angled upper surface; and
allowing the wafer cassette to slide into a proper seating position on the wafer cassette transport cart, the front-bottom edge of the wafer cassette sliding along the angled upper surface.

20. The method as claimed in claim 19 wherein the wafer cassette transport cart has pickup forks to support the wafer cassette and a transfer mechanism to transfer the wafer cassette between a processing station position and a position on the wafer cassette transport cart, the method further comprising retrieving the wafer cassette from the processing station position wherein the transfer mechanism guides the pickup forks under the wafer cassette.

21. The method as claimed in claim 20 wherein the positioning comprises transferring the wafer cassette to a position on the wafer cassette transport cart wherein the front bottom edge of the wafer cassette is positioned on the angled upper surface of the self-correcting fault-tolerant block.
